(19) United States
(12) Patent Application Publication
(10) Pub. No.: US 2026/0203712 A1
(43) Pub. Date: Jul. 16, 2026

(54) SYNCHRONISING CONSOLIDATED SHIPMENTS ACROSS DATABASES

(71) Applicant: WISETECH GLOBAL (LICENSING) PTY LTD, Alexandria, New South Wales (AU)

(72) Inventors: Angela GADAEV, Alexandria (AU); Rajah JEEVARAJ, Alexandria (AU)

(21) Appl. No.: 19/139,302

(22) PCT Filed: Dec. 14, 2023
(86) PCT No.: PCT/AU2023/051299

§ 371 Date: Jun. 13, 2025

(30) Foreign Application Priority Data
Dec. 14, 2022 (AU) 2022903844

(51) Int. Cl. G06Q 10/087

(52) U.S. Cl. CPC G06Q 10/08774

(57) ABSTRACT

This disclosure relates to a method for synchronising merged records between databases as performed by a carrier computer system. The carrier system receives from freight forwarder computer systems, booking messages. The booking messages comprise bookings for transportation of physical cargo. The system creates, in a database, a record for a consolidated booking, the consolidated booking comprising the multiple bookings. The system sends, a consolidation advice message indicative of the multiple bookings consolidated into the consolidated booking; and monitors for an acknowledgement message from the freight forwarder computer systems indicating that records in the freight forwarder computer systems that correspond to consolidated records in the carrier computer system have been consolidated in the freight forwarder computer systems to thereby synchronise the merged records.

### CROSS-REFERENCE TO RELATED APPLICATIONS

The present application claims priority from Australian Provisional Patent Application No 2022903844 on 14 Dec. 2022, the contents of which are incorporated herein by reference in their entirety.

### TECHNICAL FIELD

This disclosure relates to synchronising consolidated shipments across databases.

### BACKGROUND

Modern supply chains often involve a number of different parties, including freight forwarders and carriers. An estimated time of arrival typically depends on departure and arrival times of transportation means. For vessel-based cargo shipment, for example, the arrival time of the cargo depends heavily on which vessel the cargo is loaded. So when a freight forwarder makes a booking with a carrier, the carrier can advise which vessel the cargo will be on and the estimated departure and arrival time.

However, it is not always possible to determine on which vessel the cargo will be shipped. In particular, where cargo is transported to the carrier to be loaded into containers at the carrier, it is difficult to determine how many containers will travel on which vessels. This problem gets worse when booking are combined into a single container or a single booking. Freight forwarders often make bookings with carriers on behalf of the freight forwarder's clients. For this, the freight forwarder is required to advise the carrier how much cargo is to be shipped. However, the freight forwarder often does not have this information and typically books an estimated number of containers. Especially in situations where the freight forwarder's customer delivers good continuously to the carrier, it is almost impossible for the freight forwarder to know how to combine these deliveries into containers and then into bookings for a specific vessel. As a consequence, it is almost impossible for the freight forwarder to determine what part of the delivery will be on what vessel. Therefore, it is almost impossible for the freight forwarder to determine the time of arrival at the destination port. Further, freight forwarders are faced with the task of updating the booking many times, which increases costs, complexity and room for errors. In the alternative, there is significant space lost in containers because freight forwarders are not able to efficiently use the remaining container space due to lack of information about cargo in the current containers.

The underlying problem is often that shipment records are consolidated in one database, such as the database in the carrier system, but it is difficult for the freight forwarder to synchronise its database with the records in the carrier system. As a result, the freight forwarder cannot use cargo capacity optimally.

### SUMMARY

This disclosure provides a method that enables more accurate estimation of time of arrival. In particular, the disclosed method provides for a message generated by the carrier to advise the freight forwarder about which cargo is in a particular shipment that will be loaded on a particular vessel. More specifically, the message referred to herein as “cargo receipt advice” notifies the freight forwarder of the cargo that the carrier has received and whether it will be shipped on a particular vessel.

Disclosed herein is a method for synchronising merged records between databases as performed by a carrier computer system. The method comprises:
receiving, by a carrier computer system, from one or more freight forwarder computer systems, electronic booking messages, the electronic booking messages comprising multiple bookings for transportation of physical cargo;
creating, in a database of the carrier computer system, a record for a consolidated booking, the consolidated booking comprising the multiple bookings;
sending, from the carrier computer system to the one or more freight forwarder computer systems, a consolidation advice message indicative of the multiple bookings consolidated into the consolidated booking; and
monitoring for an acknowledgement message from the one or more freight forwarder computer systems indicating that records in the one or more freight forwarder computer systems that correspond to consolidated records in the carrier computer system have been consolidated in the one or more freight forwarder computer systems to thereby synchronise the merged records.

There is further provided a method for synchronising merged records between databases as performed by a freight forwarder computer system. The method comprises:
sending, by the freight forwarder computer system, electronic booking messages to a carrier computer system, the electronic booking messages comprising multiple bookings for transportation of physical cargo;
receiving, from the carrier computer system, a consolidation advice message indicative of multiple bookings consolidated into a consolidated booking by the carrier computer system;
consolidating the multiple bookings corresponding to the multiple bookings in the consolidation advice message to synchronise the merged records to a database of the carrier computer system; and
sending an acknowledgement message indicating that records in the freight forwarder computer system that correspond to consolidated records in the carrier computer system have been consolidated in the freight forwarder computer system to thereby synchronise the merged records.

In some embodiments, the method further comprises determining whether the consolidated bookings from the carrier computer system correspond to bookings already consolidated on the freight forwarder computer system; and upon determining that the consolidated bookings from the carrier computer system are already consolidated, sending a reject message to the carrier computer system.

In some embodiments, determining whether the consolidated bookings correspond to bookings already consolidated comprises determining whether the consolidation is inconsistent between the carrier computer system and the freight forwarder computer system.

In some embodiments, the bookings relate to bookings for sea transport.

In some embodiments, the consolidated booking relates to a single container that contains the multiple consolidated bookings.

In some embodiments, the container contains consolidated bookings from different freight forwarder computer systems.

In some embodiments, the method further comprises sending, from the carrier computer system, to the freight forwarder computer system, tracking updates on the consolidated booking while the consolidated booking is shipped.

Further disclosed herein is a method for optimising usage of cargo capacity in one or more containers. The method comprises:
sending, by a freight forwarder computer system, an electronic booking message to a carrier computer system, the electronic booking message comprising a booking for transportation of physical cargo within the one or more containers;
continuously transporting the physical cargo to a carrier cargo processing facility;
allocating, by the carrier computer system, the physical cargo to the one or more containers associated with the booking and the one or more containers to a cargo vessel;
upon completion of allocating the physical cargo to the one or more containers and to the cargo vessel, automatically creating and sending, by the carrier computer system, a cargo receipt advice message to the freight forwarder computer system, the cargo receipt advice message comprising information regarding the allocation of the physical cargo to the one or more containers and a cargo vessel;
determining, by the freight forwarder computer system, using the information regarding the cargo vessel, an estimated time of arrival of the physical cargo at a destination of the physical cargo;
determining, by the freight forwarder computer system, an unused amount of cargo capacity by determining a volume of the allocated physical cargo using the information regarding the allocation of the physical cargo and subtracting the volume from the cargo capacity;
adding, by the freight forwarder computer system, further cargo to the booking to reduce the unused amount of cargo capacity; and
creating, by the freight forwarder computer system, a bill of lading for the booking including the physical cargo and the further cargo.

In some embodiments, the method further comprises sending, by the freight forwarder computer system, electronic booking messages to the carrier computer system, the electronic booking messages comprising multiple bookings for transportation of physical cargo.

In some embodiments, the method further comprises creating, by the carrier computer system in a database of the carrier computer system, a record for a consolidated booking, the consolidated booking comprising the multiple bookings.

In some embodiments, the method further comprises receiving, from the carrier computer system, a consolidation advice message indicative of multiple bookings consolidated into a consolidated booking by the carrier computer system.

In some embodiments, the method further comprises consolidating, by the freight forwarder computer system, the multiple bookings corresponding to the multiple bookings in the consolidation advice message to synchronise the merged records to a database of the carrier computer system.

In some embodiments, the method further comprises monitoring for an acknowledgement message from the one or more freight forwarder computer systems indicating that records in the one or more freight forwarder computer systems that correspond to consolidated records in the carrier computer system have been consolidated in the one or more freight forwarder computer systems to thereby synchronise the merged records.

In some embodiments, the method further comprises sending, by the freight forwarder computer system, an acknowledgement message indicating that records in the freight forwarder computer system that correspond to consolidated records in the carrier computer system have been consolidated in the freight forwarder computer system to thereby synchronise the merged records.

In some embodiments, the method further comprises performing by the freight forwarder computer system the steps of:
determining whether the consolidated bookings from the carrier computer system correspond to bookings already consolidated on the freight forwarder computer system; and
upon determining that the consolidated bookings from the carrier computer system are already consolidated, sending a reject message to the carrier computer system.

In some embodiments, determining whether the consolidated bookings correspond to bookings already consolidated comprises determining whether the consolidation is inconsistent between the carrier computer system and the freight forwarder computer system.

In some embodiments, the consolidated booking relates to a single container that contains the multiple consolidated bookings.

In some embodiments, the container contains consolidated bookings from different freight forwarder computer systems.

A computer system comprises one or more processors that are configured to individually or in combination perform the method of any one of the preceding claims.

### BRIEF DESCRIPTION OF DRAWINGS

FIGS. 1a, 1b, lc illustrate an example of progressive bookings with multiple customers.

FIG. 2 illustrates a further example with five shipments from freight forwarder 101 and two shipments from another forwarder 113 and the NVOCC 102 that handles the shipments.

FIG. 3 illustrates how NVOCC created Co-Load Master Shipments, each including multiple individual shipments.

FIG. 4 illustrates how to create consolidations and group shipments together.

FIG. 5 illustrates an example where freight forwarder has created consols F1 and F2 and requested individual bookings for the shipments in the respective consols.

FIG. 6 illustrates the first part of a flow-chart for a booking request from shipment and consolidation by NVOCC process.

FIG. 7 illustrates the first part of a flow-chart for a booking request from shipment and consolidation by NVOCC process.

FIG. 8 illustrates a NVOCC integration message flow.

FIG. 9 illustrates a message flowchart.

### DESCRIPTION OF EMBODIMENTS

This disclosure relates to methods and systems for communicating ocean bookings between a first entity, such as a freight forwarder, and a second entity such as a non-vessel operating container carrier (NVOCC). The NVOCC acts as a carrier in the sense that freight forwards can make bookings for a number of containers, for example, but the NVOCC itself does not operate any vessels. This means the NVOCC cannot directly provide information about which vessel will carry the booked containers and cannot directly provide the departure and arrival time of a specific vessel and therefore of a specific container.

In one example, the disclosed method is implemented within a cloud-based service and each user of the cloud based service may have software installed (“system”) on their local user computers to interface with the cloud-based service. The users may also have a web-based form to interact with the cloud-based service.

It is possible to create an electronic booking. But it has been found that existing processes have a missing link when a message relates to a communication or booking between two freight forwarders. The difficulty arises, for example, where customers book entire containers. The freight forwarder/shipper contacts the carrier and requests for a number of cargo boxes to be shipped. The carrier accepts it. Once the cargo boxes are assigned to a vessel, the carrier issues a bill of lading, which essentially is a contract that goods will be available at the other end.

In an example situation a freight forwarder books with NVOCC. But at that stage cargo is not containerised. It would be an advantage if the freight forwarder could consolidate, and/or collude with other freight forwarders. Smaller freight forwarders give cargo to bigger ones. For example, a large freight forwarder books 50 containers and commonly has some left over. Instead of waiting for next shipment, the freight forwarder can offer the left over containers to other parties. This means that the containers are filled more optimally because they can be filled with available cargo while previously the container would have been shipped with empty space.

It is now clear from the above description that there is an unknown element of what cargo is actually being used to fill the booked containers. In some cases, unlike on vessel where it is known how many containers the vessel can take or on which vessel the containers can be carried, in many cases the cargo does not fit onto the vessel or into the booked number of containers. Therefore, the cargo often is offloaded to the next vessel, which delays the arrival significantly. When an NVOCC is involved, the assignment of cargo to vessels is an unknown process because those carriers do not operate the vessels themselves.

The problem gets more complicated when a smaller freight forwarder/booking party has an agreement with a customer (manufactures, retail, etc.). That agreement may state that every Friday the customer will deliver cargo of an approximate volume. The freight forwarder agrees to ship that cargo with a NVOCC. However, the cargo might arrive progressively, and therefore is provided to the NVOCC gradually or by batches, such as by truck loads. But the NVOCC does not know how much cargo will be loaded on a regular basis.

The process disclosed herein relates to notifying the NVOCC of cargo. Forwarder does not know how many boxes arrive at NVOCC. This disclosure provides a process “cargo receipt advice” message. This is an electronic message and essentially means that the NVOCC has received the specified cargo from the freight forwarder's customer.

This disclosure further provides an electronic message for “consolidation advice”. For example, a first freight forwarder instructs a second freight forwarder to ship cargo. The first freight forwarder authorises its customer to deliver cargo to the second freight forwarder's warehouse. The second freight forwarder has bookings with carriers for number of containers. The second freight forwarder has cargo coming from many customers. Then, the second freight forwarder may pack the booked containers only with the cargo delivered for the first freight forwarder or with others' cargo. But the first freight forwarder should know how their customer's cargo was shipped/consolidated.

Therefore, this disclosure provides for a new message to indicate consolidated cargo. This applies to progressive cargo so that the beneficial owner knows about the consolidation. It is a complex process to track all of the required information given the large amount of cargo that is shipped every day globally. As a result of the gap in current systems, many forwarders are not able to fill their containers optimally because they do not have the data required for consolidation. Therefore, according to this disclosure, the NVOCC will send advice back to the second freight forwarder to indicate how many boxes have been included into the Master Bill (to be loaded on a particular vessel). The second freight forwarder sends consolidation advice to the first freight forwarder advising how their cargo was consolidated. The advice is an electronic message that is sent to the computer system of the first freight forwarder, which keeps records of all its small shipments. Finally, the computer system of the first freight forwarder can groups together cargo that has been consolidated into a single container or onto a single vessel. Therefore, the first freight forwarder is now able to provide a more accurate estimated time of arrival for the cargo.

There are a number of technical advantages that arise from the use of the methods disclosed herein. Firstly, the databases at the freight forwarder and the carrier are synchronised. This is achieved by sending messages that are triggered by data updates. In particular, the consolidation of multiple shipments into a consolidated shipment is naturally difficult because each shipment is its own record. A consolidated shipment is therefore a different record and references the shipments that are contained therein. The consolidation advice therefore is a message that exchanges information about the consolidation of database records. It does not, in itself, contain any new data that is contained in the records, but only confers the information about the consolidation. The consolidation message is therefore a systematically different type of message that leads to the advantage of synchronising a database update that consolidates multiple shipment records.

Further, as an alternative, it may be possible to send update messages on each of the consolidated records. For example, if the carrier consolidates five shipments, the carrier may send an update message on each of the five shipments and include a reference to the same consolidated record. However, this would require five shipment updates. In contrast, with the disclosed method, there is only a single consolidation advice message regardless of the number of shipments that have been consolidated. As a result, the message overhead is reduced n-fold where the n is the number of consolidated shipments.

Thirdly, since it is now possible to consolidate shipments and advise the freight forwarders of the consolidation, it is more often possible to use cargo space that would have remained empty otherwise as described herein. As a result, the overall throughput of the entire supply chain is increased.

It is noted again, that the booking by the freight forwarder can be seen as a reservation of cargo space. However, the allocation of that space to specific cargo is typically not performed by the freight forwarder but by the carrier. Once the information about consolidation etc. is available to the first freight forwarder, the first freight forwarder sends shipping instruction to the second freight forwarder. In turn, the second freight forwarder creates a Bill of Lading, which is a legal document or contract that is strictly with predefined requirements.

According to this disclosure, the cargo is split over multiple containers automatically in the first freight forwarder's system. In one example, all involved entities, and in particular the first freight forwarder and the second freight forwarder, are connected using the same cloud-based software system, such as CargoWise by Wisetech Global. However, the disclosed method can equally send the electronic message to different systems.

While the electronic message advises how cargo is grouped, the message also indicates which vessel will carry the cargo and when the cargo will be delivered.

Once the first freight forwarder is to generate shipping instructions, they know which shipments were grouped. The first freight forwarder then provides addresses for delivery to the second freight forwarder. In that example, the second freight forwarder is referred to as the master and is considered the carrier for the first freight forwarder. Conversely, the first freight forwarder can be considered to be the carrier for the first freight forwarder's clients. The first freight forwarder has a house bill of lading, while the second freight forwarder generates the master bill of lading.

One advantage of the disclosed methods is the full automation, which is important for high volumes and reduces manual handling of shipment data significantly. Again, this is particularly relevant where supply chain parties want to send cargo progressively and all cargo arrived before a time cut-off go onto a particular vessel. It is useful to know how much goes on that vessel so that remaining capacity can be filled efficiently and automatically.

Once the electronic advice message is received in the first freight forwarders computer system, it causes the computer system to re-arrange the data so that (i) the correct vessels are now associated with a specific shipment and (ii) the remaining space on the vessel or the container(s) is used with other cargo. As a result, the vessel is loaded to a higher capacity, which means a higher amount of cargo can be transported for an almost identical cost. This reduces the fuel used per cargo shipment, which directly reduces carbon emissions. Further, the improved process allows for accurate calculation of an estimated time of arrival.

In a further example, the proposed system recognises its own customers. This does not require configuration from any user. In a further example, the proposed system comprises master reference data of carriers capable of receiving electronic bookings. If carriers are external to the system, it is possible to guide them to be able to process the electronic messages. When they select carrier in the system disclosed herein, the system approves them as authenticated customers. As a result, the electronic messages address the right system on the freight forwarder side. That is, the messages go back to the first freight forwarder system. The second freight forwarder has received and accepted the booking, rejected or accepted the booking. The generation of the electronic messages is all automated-requiring no human intervention.

As set out above, this disclosure provides a shipment-level process while other processes are on consolidated cargo, which brings about the disadvantages set out above. In yet a further example, in cases where a container is loaded with cargo from different customers, such as different first freight forwarders, the disclosed system sends a separate consolidation advice message to each customer. However, each message contains only information of that one customer so that the information of the other customers remains confidential even though their cargo has been consolidated into a single container.

The following description provides further details on shipment level booking. In the following example, the above mentioned “first freight forwarder” is simply the “forwarder” and the above mentioned “second freight forwarder” is the “carrier” or “NVOCC”. The disclosed method comprises the following steps:
1) Forwarder sends a booking
2) NVOCC's recipient's system creates a Booking/Shipment
3) NVOCC confirms a booking
4) NVOCC creates a Consol and attaches bookings/shipments (does not have to be in this order)
5) CFS/Transit Warehouse receives cargo and advises Forwarding (does not have to be in this order)
6) NVOCC confirms Cargo Receipt (sending Cargo Receipt to a Forwarder)
7) NVOCC creates Co-Load Master Shipment
8) NVOCC sends Consolidation Advice to Forwarder
9) Forwarder Sends Shipping Instruction from a Consol
10) NVOCC processes Shipping Instruction
11) NVOCC creates Co-Load Master Shipment House Bill

### Forwarder Sends a Booking

When a booking is sent to a shipment, the real shipper/consignee can be masked with Forwarder/Sender organisation for privacy and data protection.

Options for Sending a Booking from Forwarding

a) Consol level booking: The freight forwarder sends a booking request including one consol comprising a first shipment and a second shipment to the NVOCC. Consol or Consolidation refers to the case when the cargo from two or more shippers is loaded into the same container or on the same pallet and tendered together to the carrier as one shipment on one MAWB or MBL.

b) Shipment level booking from standalone shipment: In this case the freight forwarder sends the booking request that comprises only a single shipment to the NVOCC.

c) Shipment level booking from a Shipment on a Consol: The freight forwarder sends each shipment in the consol as separate booking requests to the NVOCC. I.e. A user can send a booking from a Shipment on a Consol, and then another booking from another Shipment on the same Consol

d) A booking can be sent from a Consol OR from a Shipment, but not both.

I.e. if a user sends a booking from a consol (one booking request from the freight forwarder to the NVOCC for multiple shipments in the consol. An attempt to later send a booking from a Shipment on the same Consol will result in error.
If a user sends a booking from a shipment on a consolidated consol, it's possible to send another booking from another shipment on the same Consol, but an attempt to also send a booking request from the same Consol (which has at least one shipment with the booking already sent) will result in error.

To overcome the problem, a user will need to withdraw booking/s and get confirmation of withdrawal from the NVOCC or reset consol or shipment level booking to original and advise NVOCC accordingly to stay in sync.

### NVOCC Recipient's System Creates Booking/Shipment

NVOCC system, receiving a booking, will create a Shipment on NVOCC site per booking request (no Consols will be created on NVOCC).

If no job exists on NVOCC site, a booking will be created and NVOCC can confirm it to a shipment. If a matching booking is found on the recipient system, this booking will be updated. If a matching shipment is found on the recipient system, this shipment will be updated. NVOCC booking/shipment can already calculate statuses for inbound messages.

a) Consol level booking generates a single booking/shipment on NVOCC site

b) Shipment level booking from standalone shipment generates a single booking/shipment.

c) Multiple individual Shipments on the forwarder site will generate multiple corresponding shipments on the NVOCC site.

d) Shipment level booking from a Shipment on a Consol generates a shipment on the NVOCC site.

e) Multiple Shipments generate individual bookings from the same Consol end up with one shipment created per booking on the NVOCC site.

### NVOCC Confirms a Booking

Booking confirmation is generated by NVOCC site per booking/shipment created at the NVOCC site. Booking Confirmation message is sent from a Forwarding>Booking or Shipment. Booking Confirmations can already be generated by recipient system as per the above.

a) Consol level booking will generate Booking Confirmation that will be sent from NVOCC to the forwarder.

b) Shipment level booking will generate Booking Confirmation that will be sent from NVOCC to the forwarder.

c) Multiple shipment's bookings will generate one confirmation per booking.

d) Shipment level booking from a Shipment on a Consol will receive booking confirmation back to the shipment.

e) Multiple Shipments on the same Consol which generated a booking each, each will receive a booking confirmation.

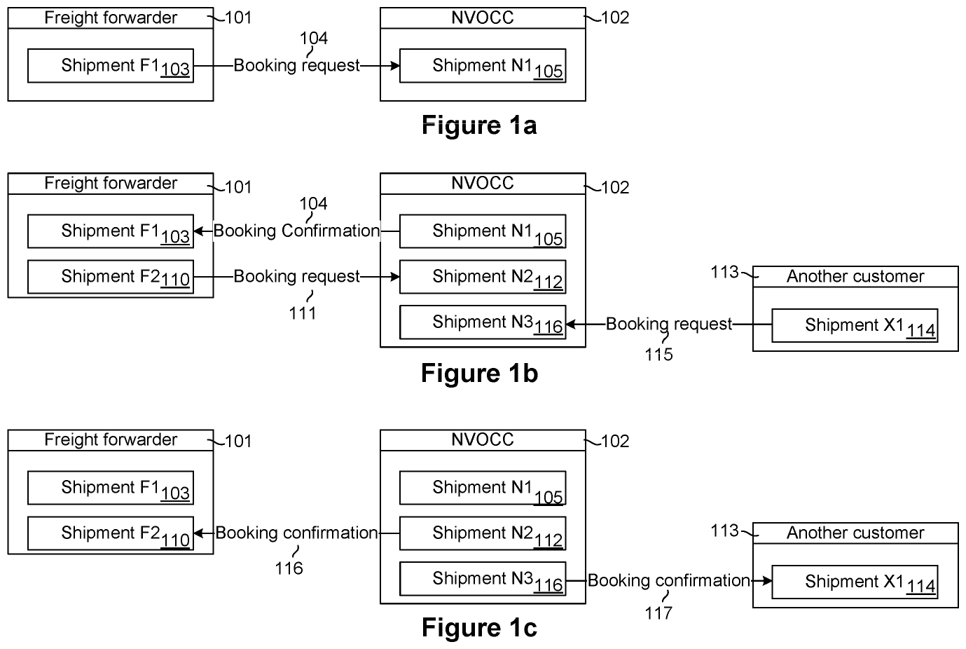

FIGS. 1a, 1b, 1c illustrate an example of progressive bookings with multiple customers. In particular, in FIG. 1a there is freight forwarder 101 and NVOCC 102. Freight forwarder 101 has created a first shipment 103. It is noted that the freight forwarder 101 and NVOCC 102 each have their respective separate set of shipments as records on separate databases. There is a need for keeping those separate records synchronised in the sense that the freight forwarder 101 has correct records that correspond with the records of the NVOCC 102. This synchronisation of database records is achieved through the sending of messages between the freight forwarder 101 and the NVOCC 102.

There is a problem with defining those messages because the interacting parties need to know which message types are available. In that sense, there is provided a messaging protocol that defines each message type. As such, if a new message type is introduced, all participating parties update their communication modules to incorporate the new message type. Therefore, it is difficult to re-define the set of message types, so care should be taking in defining the right number of message types.

At one hand, the number of different message types should be low so as to keep the messaging protocol simple. On the other hand, a larger number of different message types allows more complex update instructions, more efficient database updates and synchronisation and more different user scenarios.

The definition of new message types has the technical advantage that fewer messaging operations are necessary because multiple steps can be performed at each side of the communication at once in response to receiving a single message. Such a messaging-based database update scenario is technically difficult to define and has significant ramifications on the performance of the database update operations. Especially in cases where changes to the separate databases occur frequently, the need for an efficient messaging protocol is apparent.

For example, in container shipping operations, the changes to database states of individual shipments is immense, so an efficient messaging protocol with the right number of messages is important. Further, the messaging needs to be robust because an inconsistency in the record data leads to significant disruptions is shipping operations, including stranded containers and accumulation of containers at ports.

In the example of FIG. 1a, freight forwarder 101 has created a record for shipment F1 103. It is noted that the capital letters indicate the database. That is, ‘F’ stands for the database of the freight forwarder 101. Freight forwarder 101 sends a booking request 104 to NVOCC 102, which, in turn, creates a record 105 on its own database for shipment N1. Here, ‘N’ stands for the database of NVOCC 102. Once NVOCC 102 has created record 105, the shipment can progress but freight forwarder 101 has not yet updated its own records that the shipment can proceed.

Therefore, NVOCC 102 sends a booking confirmation 104 (see FIG. 1b) to freight forwarder 101, which, in turn, updates its F1 record 103 to indicate that the shipment has been confirmed by NVOCC 102. As a result, the shipment F1 record 103 and shipment N1 record 105 are synchronised between freight forwarder 101 and NVOCC 102.

In FIG. 1b, freight forwarder 101 creates a further shipment 106, sends a further corresponding booking request 111 and in response, NVOCC 102 creates a further shipment record N2 112. In contrast to FIG. 1a, another customer 113 also creates a shipment X1 114 and sends a corresponding booking request 115 to NVOCC 102, which, in turn creates shipment record N3 116. Accordingly, as shown in FIG. 1c, NVOCC 102 sends booking SUBSTITUTE SHEET (RULE 26) confirmation 116 to freight forwarder 101 and booking confirmation 117 to the other customer 113. As a result, shipment F2 110 is synchronised with shipment N2 112 and shipment X1 114 is synchronised with shipment N3 116. This means that four shipments across three databases are synchronised, which avoids data inconsistencies.

### NVOCC Creates a Consol and Attaches Bookings/Shipments

At any time in the above process NVOCC can create a consolidated shipment (Consol) and start attaching bookings/shipments to it. A consol can even be created and booked with a carrier in advance. If a Booking Confirmation is sent from a Consol, it includes routing details.

### NVOCC Confirms Cargo Receipt (Sending Cargo Receipt to a Forwarder)

Forwarder instructs CFS/Transit Warehouse (TW) to receive cargo.

Proposed process:
Cargo Receipt Notification will be the new message that can be sent by NVOCC from a Forwarding>Shipment>Actions menu or similar.

This message will go the same target (i.e. a shipment or a consol on the Forwarder site) as Booking Confirmation described above, but if a target is a shipment (not a consol) it will override packlines of the original shipments with correct pack count, type, dims and weight. This could be somewhat similar to the process when Transit Warehouse (not legacy CFS) updates shipment packlines but instead it will update packlines on the sender's system.

This could be a Workflow Trigger and may trigger sending Dims back to forwarder, but may be an option to allow/disallow updating on their system. That is, the user (sender/Toll) will be able to review and accept changes to pack lines before they issue HBLs to their shippers.

### NVOCC Creates Co-Load Master Shipment

This step can happen at earlier stages. Shipments created from forwarder bookings can be attached to the Co-Load Master Shipment

### NVOCC Sends Consolidation Advice to Forwarder

Consolidation Advice will be a new message generated from a Co-Load Master Shipment to advise the forwarder how their shipments were consolidated by NVOCC. One aim is to issue a single Master House Bill from NVOCC to a forwarder.

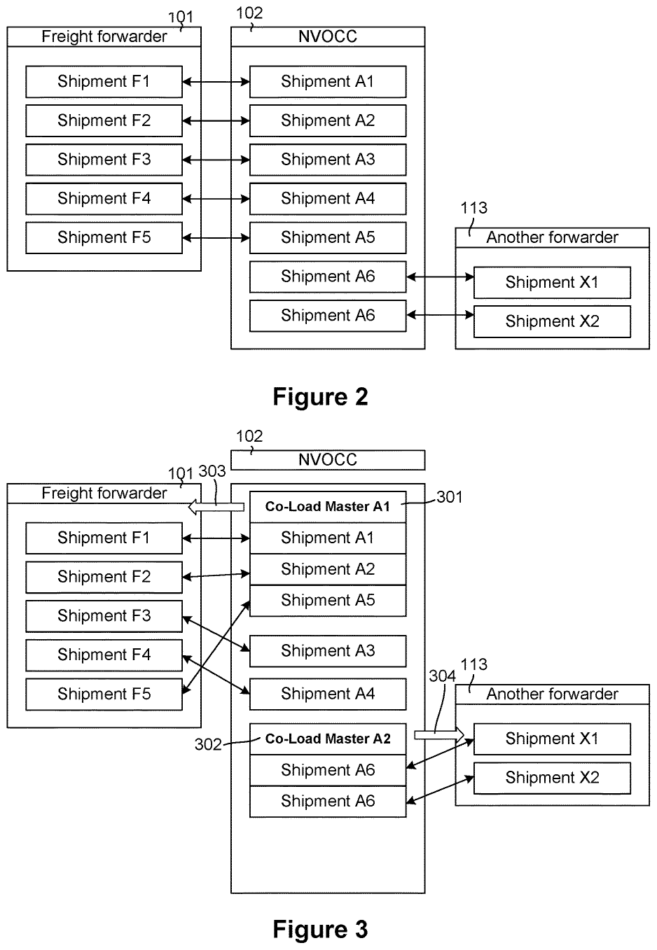

FIG. 2 illustrates a further example with five shipments from freight forwarder 101 and two shipments from another forwarder 113 and the NVOCC 102 that handles the shipments. All shipments on the NVOCC 102 were created from standalone shipments of the sending forwarder 101/113. It is noted that the messages for requesting and confirming shipments are now represented by double arrows.

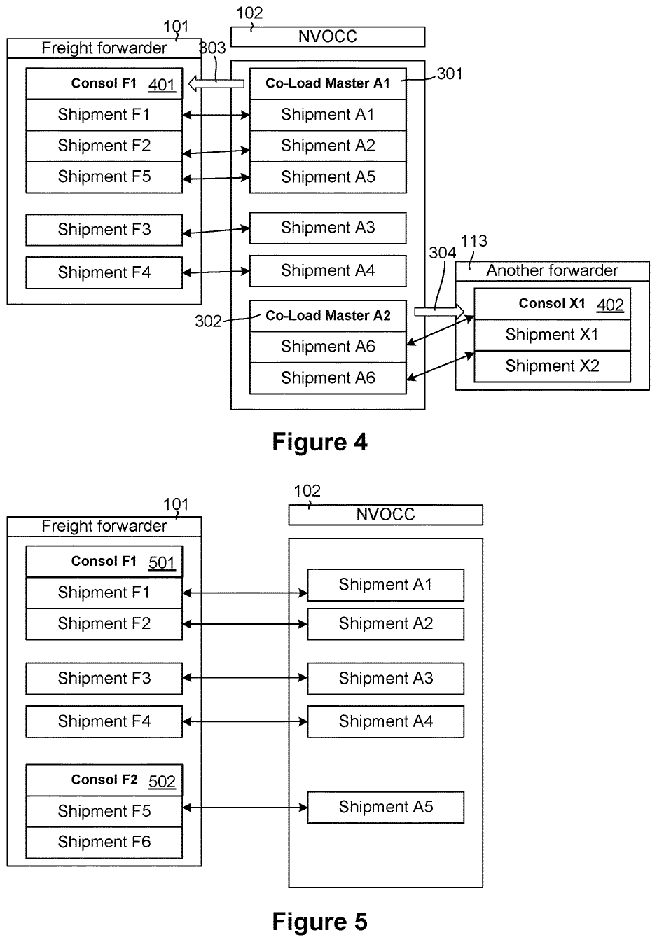

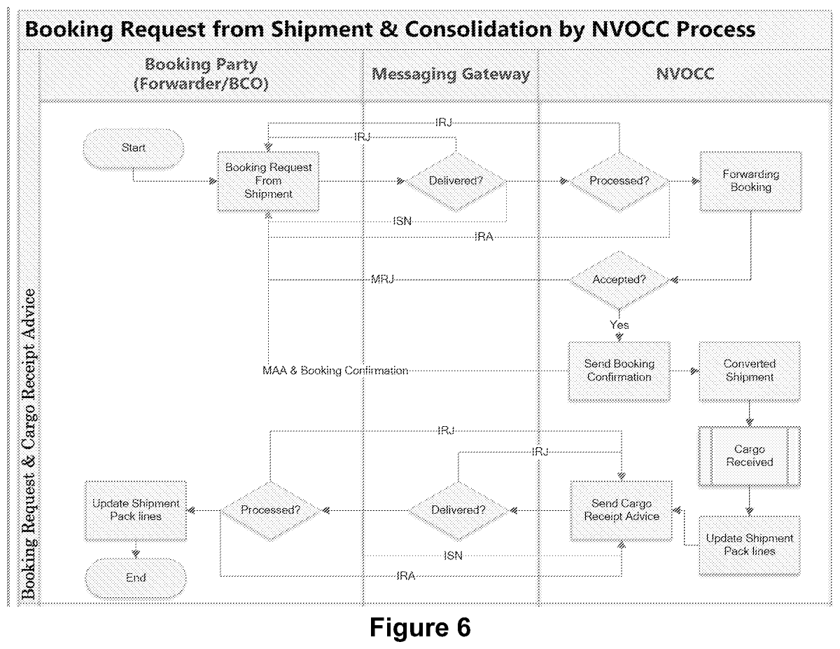

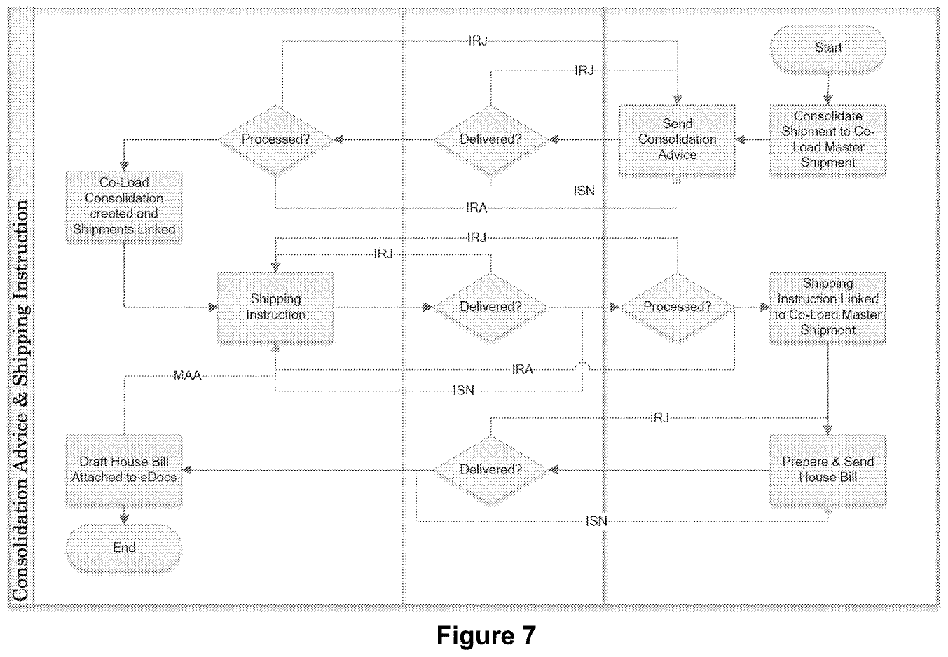

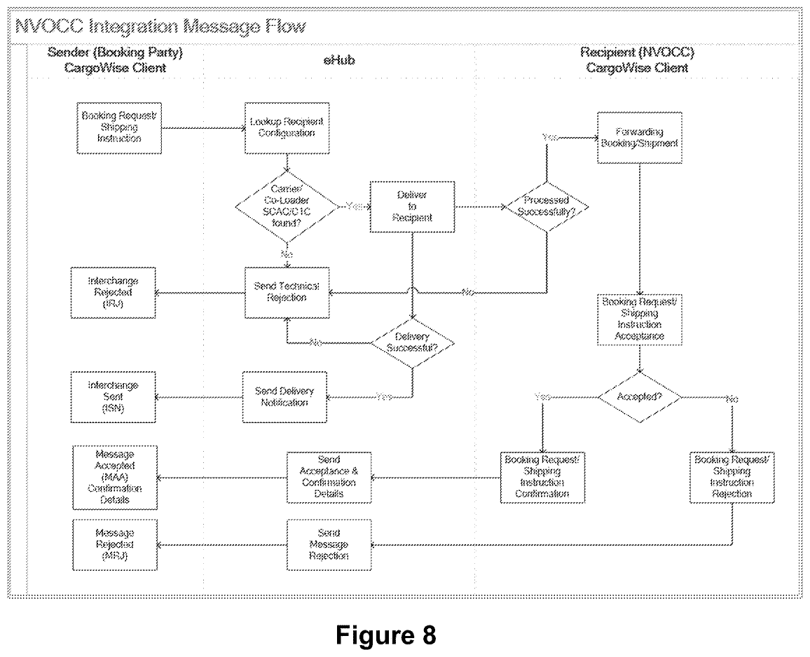

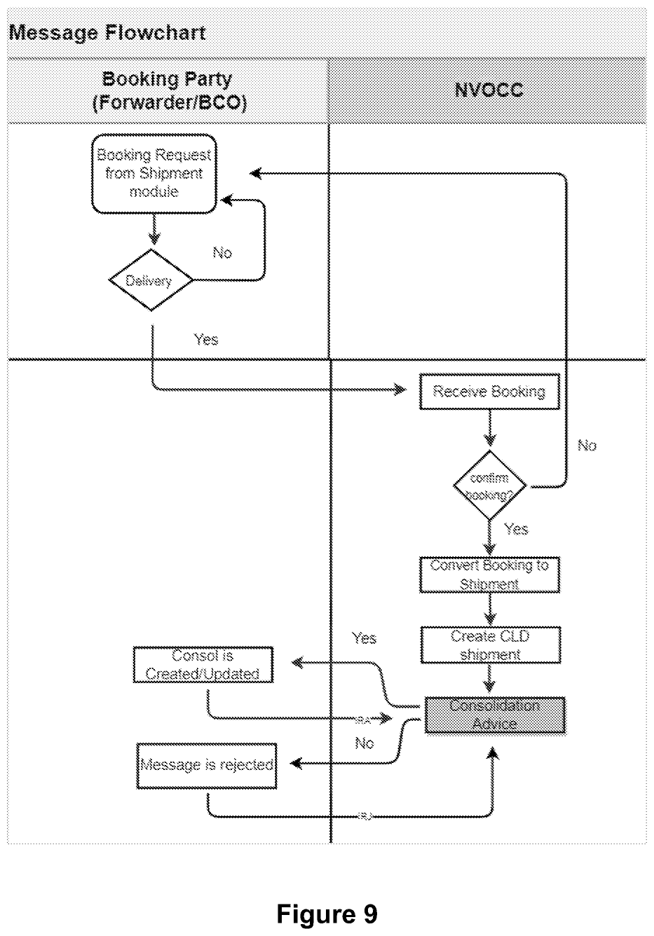

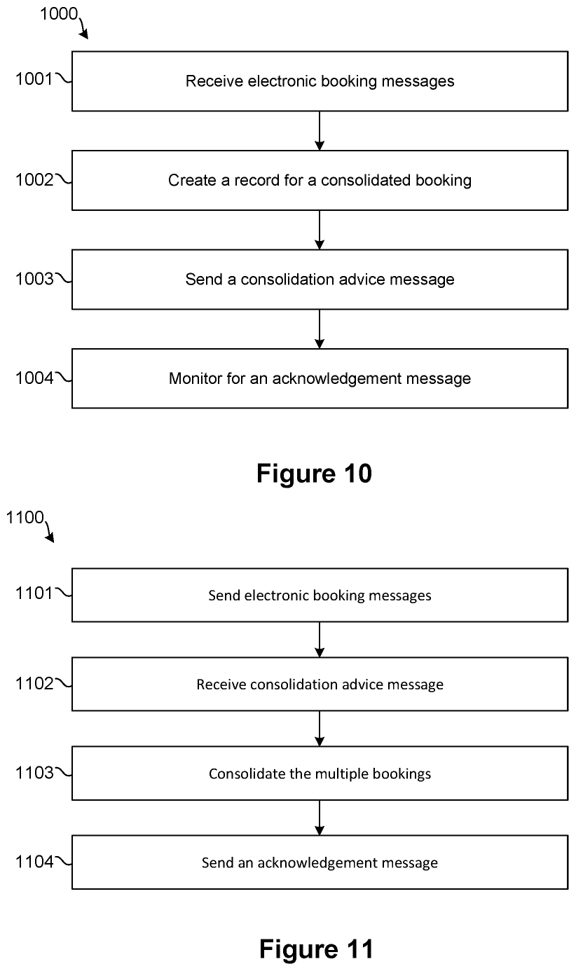

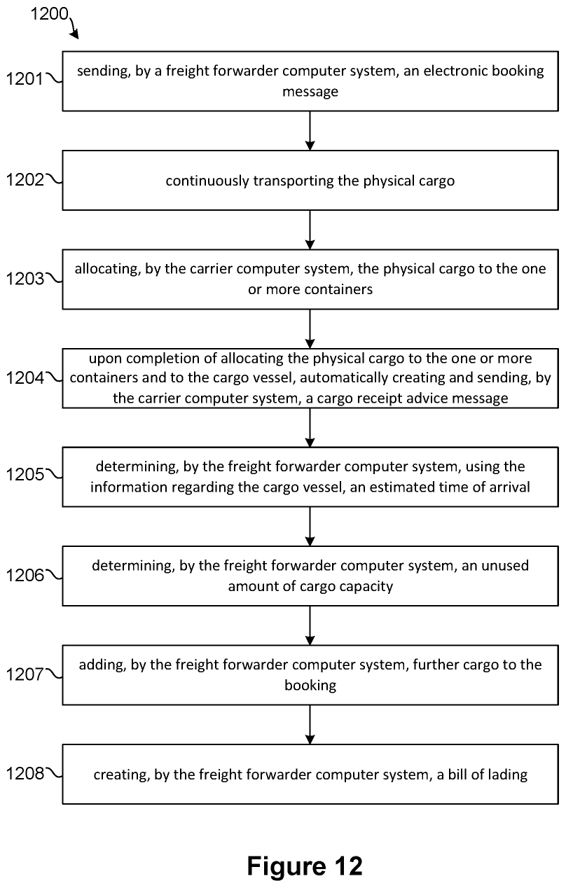

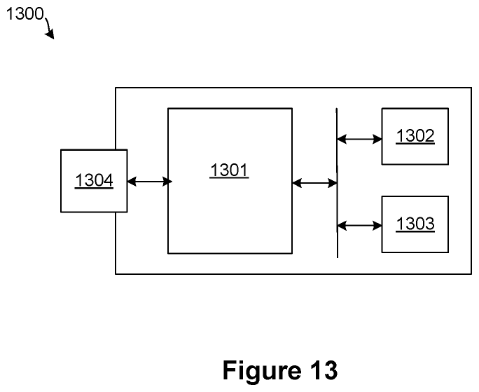

FIG. 3 illustrates how NVOCC 102 created Co-Load Master Shipments 301 and 302 each including multiple individual shipments. NVOCC 102 will be able to send a Consolidation Advice from Co-Load Master A1 301 to freight forwarder 101 as indicated at 303, and from Co-Load Master A2 302—to Another Forwarder 113 as indicated at 304. Consolidation Advice received by a Forwarder system 101/113, will create consolidations and group shipments together as shown in FIG. 4. Freight forwarder 101 now has a first consol F1 being synchronised with co-Load Master A1 301. The other freight forwarder 113 has a consol X1 402 being synchronised with Co-Load Master A2 302.

If at the time of sending Consolidation Advice the receiving forwarder system contains consolidations with the shipment numbers included into the Consolidation Advice, the message will be rejected by the recipient system and the forwarder will need to manually create consols and apply NVOCC's Booking Reference and Master Bill in order to proceed with Shipping Instruction.

FIG. 5 illustrates an example where freight forwarder 101 has created consols F1 501 and F2 502 and requested individual bookings for the shipments in the respective consols. Shipments F1 and F2 shipments were booked individually from a consol, note the consol could have been created by the forwarder LATER, after booking requests were sent. Shipments F3 and F4 were sent and remain standalone shipments in the Forwarder system. Shipment N5 was created as a result of a booking from the consol level Consol F2, and now Consol F2 also has an unknown shipment F6).

NVOCC 102 can group some of the shipments to a Co-Load Master Shipment and send Consolidation Advice. For example, NVOCC 102 may group shipments A1, A2 and A5 into one Co-load Master and send a consolidation advice. However, this consolidation advice message will be rejected by the recipient's system because Shipments T1 (=A1), T2 (=A2) and T5 (=A5) are already consolidated and it can be different to what NVOCC had planned. In one example, there is a trigger for sending back ‘Consolidation’ Advice. There may be a new status (when a user changes the status, it generates a message) or an action menu to trigger Consolidation Advice, NVOCC 102 will activate it when they are ready, rather than sending it back to freight forwarder 101 on each new sub added to Co-Load Master. If there is a stand-alone shipment, NVOCC 102 would not create a consolidation advice for it (see above F3-A3 for example) since the individual bookings have already been confirmed.

### Forwarder Sends Shipping Instruction

Shipping Instruction to the NVOCC can be sent from a forwarder's Consol in the following cases:

The sender's consol:
1) Has an original Booking Request at the Consol level (and no bookings were sent from the shipments on this consol), has valid booking confirmation at the consol level and no Consolidation Advice message.
2) Has no bookings generated at either a consol or any of the shipments level, i.e. when a forwarder can send an SI to an NVOCC without a booking (this case is supported by 3^{rd} party NVOCC's)
3) Has corresponding Consolidation Advice:
   In this case SI will include all sub-shipments to be matched against the recipient's NVOCC Co-Load Master Shipment. This can be achieved by building a system calculated flag indicating that when a consol is created from Consolidation Advice it would include all the subs in the SI.

### NVOCC Processes Shipping Instruction

Cases 1 and 2 under “Forwarder Sends Shipping Instruction” above allow consols on sender's site to correspond to shipments on NVOCC recipient site without co-load master shipments. Case 3 will receive Shipping Instruction containing Co-Load Master and sub-shipment details and will match not only consol references (co-load master bill and booking ref etc.) but also each shipment to sub-shipments of the NVOCC's co-load master). This is done to ensure that no additional unknown or not previously consolidated shipments are pushed.

Additionally, pack lines previously confirmed by Transit Warehouse/CFS, if they were altered by a sender, will not update the pack lines of the sub-shipments of the Co-Load Master. We would use parameters described in the step S above: presence of the CFS/TW facility, status (RCV or even DSP) and the date to identify if the pack lines that were verified by CFS and cannot be changed. We will document it in the update note.

A Shipping Instruction document received by NVOCC 102 can be visualised and available in eDocs, highlighting to NVOCC 102 all discrepancies between Co-Load Master with subs in NVOCC 102 system vs freight forwarder 101 consol with shipments. E.g. we can highlight different packages information, count, dims, weight etc. so NVOCC 102 can audit and discuss with freight forwarder 101 possible discrepancies. Pack lines suggested by freight forwarder 101 will be flagged as ‘not updatable’, but will be visible on the SI document.

### NVOCC Creates Co-Load Master Shipment House Bill

HBL from Co-Load Master Shipment will be created in Form Builder and will have two optional configurations (self-customisable by the user) to either show the summary of all packages or group pack lines by shipment and show details of each shipment pack line (similar to a HBL printed from this shipment).

Electronic Receipt of Bookings and Shipping Instructions from Other Systems

The disclosed method allows NVOCC users of the disclosed system forwarding to electronically receive and process Booking Requests and Shipping Instructions from their customers, who are also users of the system.

Booking Request and Shipping Instruction created from the Forwarding>Consolidations module in one instance can now be electronically received to a Forwarding>Bookings or Forwarding>Shipments modules of another instance of the system without the need for any mapping and extra configuration from either site.

Unlike other connectivity, supporting the interchange of Forwarding Bookings, Shipments and Consols between different instances of the system, new functionality extends the ability of ocean carrier Booking Request and Shipping Instruction FormBuilder messages to be processed not only by ocean carriers and external NVOCC's, but their own Forwarding system.

The process comprises: Create Booking Request and/or Shipping Instruction using existing Consol>Carrier Messaging>Booking Request and/or Shipping Instruction functionality, selecting the NVOCC organization as a ‘Co-Load With’ organization.

Send the message, receive back acknowledgements, confirmations, rejections, draft bills, as from other carriers/NVO.

If the NVOCC does not have a record in the Shipping Lines reference file or user is not registered with this NVOCC via eHub (user will see validation error in both cases if user tries to send a message), user would create an eRequest as per the instruction above.

### Receipt of Booking Request/Shipping Instruction

If user is an NVOCC receiving electronic Booking/SI messages, user should:

Ensure that user company name is listed in Reference Files>Shipping Lines.

Register with the system to receive messages from other system users.

User customer's Organization (message sender, which is a booking party you expect to receive electronic bookings/SI from) company name and address exist in user's system. FIG. 3 illustrates a corresponding Process Flow.

As disclosed herein, NVOCC users of the system can now generate Consolidation Advice electronically to their customers (which can be another freight forwarder, shipper, or Beneficial Cargo Owner (BCO) on the system). NVOCC/wholesaler/consolidator can use this feature to advise their customers on how cargo tendered to/co-loaded with the NVOCC was consolidated by NVOCC.

A Consolidation Advice message, generated by an NVOCC system and advising how booked cargo was consolidated by the NVOCC, will be processed into the system of the booking party and will create or update a consolidation of the booking party system, that will group together shipments consolidated by the NVOCC.

The Consolidation Advice is used by the NVOCC to send consolidation information to a booking party (shipper, another forwarder or BCO), who has previously sent booking requests from each individual Shipment.

For an NVOCC progressively receiving bookings/shipments from their customer, NVOCC will choose how to best consolidate these bookings/shipments by creating a new Co-Load Master Shipment and attaching those shipments as sub-shipments to that Co-Load Master.

Once the Co-Load Master Shipment is created on the NVOCC side for the same booking party, the NVOCC can issue electronic Consolidate Advice to notify the booking party on how these shipments were consolidated. The Consolidation Advice message, sent by NVOCC, will be received by the booking party's system, and will create or update existing Co-Load (CLD) Consolidation automatically, attaching all the relevant shipments to this Consol. FIG. 4 illustrates a corresponding flow chart.

A booking party can create electronic booking request to NVOCC either from a co-load consolidation or from an individual booking or shipment. Both of these methods create a booking or a shipment (not a consol) on the receiving NVOCC system. Consolidation Advice process applies only to bookings created from the shipment level. If a booking request was sent by a booking party from a consol resulting in a shipment being created on NVOCC system, this shipment may not be included to Consolidation Advice.

A Consolidation Advice message received from an NVOCC will be processed into the system of the Booking Party and will create new or update an existing consolidation and attach to it shipments consolidated by the NVOCC. Upon receipt of Consolidation Advice by the booking party system, CargoWise will use Co-Load MBL and/or Co-Load Booking Reference fields to match and update the existing Consolidations.

A new Co-Load Consolidation will be created in Booking Party's system if NO matching consolidation is found.

If the existing Consolidation has the shipment numbers that match the sub shipment numbers in the Consolidation Advice message, but the Consolidation has no Co-Load Booking Ref and/or Co-load MBL entered, system will still match this Consolidation and update it.

In other words, if you've submitted booking requests from your bookings/shipments and then later manually created a CLD consol in your CargoWise without co-load master bill and/or booking reference, Consolidation Advice will match to this consol and update it.

If existing Consolidation is successfully matched but if the Consolidation type is not CLD, then the Consolidation will be converted to CLD by the Consolidation Advice message.

If existing Consolidation is successfully matched but it has Shipments that are not included in the Consolidation Advice message, then those Shipments will be detached from the Consolidation, and only the Shipments sent in the Consolidation Advice message will be attached to this Consolidation.

In other words, if you have created Consolidation in your system, but included more shipments than were consolidated by NVOCC, these extra shipments will be detached from the consolidation to match with the NVOCC system.

If existing Consolidation A is successfully matched but at least one shipment in the Consolidation Advice message was attached to Consolidation B by the Booking Party, then the Consolidation Advice will be rejected with message: ‘Shipment(s) on Consolidation Advice has been linked to another Consolidation’. Interchange Rejection (IRJ) event will be sent back to NVOCC with above reason.

If Consolidation Advice is received with additional Shipments besides those that have been attached to the matched Consolidation, and the additional Shipments are not attached to another Consolidation, then the additional Shipments will be automatically attached to this Consolidation.

If Consolidation Advice is received with additional Shipments besides those that have been attached the matched Consolidation, and at least one additional Shipment is attached to another Consolidation, the Consolidation Advice will be rejected.

In case of an amendment Consolidation Advice (Document Name=‘Consolidation Advice’ and Purpose=‘AMD’), the Booking Party's system will try to find a matching Consolidation using the following criteria:
‘CoLoadBookingConfirmationReference’ match the Co-Load Bkg Ref in the consol; and/or.
‘CoLoadMasterBillNumber’ match the Co-Load MBL in the consol; and/or.
Value of AdditionalReference of Type ‘HIR’ match the Consolidation>Details>Numbers [Type=HIR]

Then all Shipments in the Consolidation Advice message will be validated to check if they are attached to another Consolidation or not. If none of shipments are linked to another Consolidation, then the matched Consolidation can be updated:
New matching shipments will be attached
Shipments which do not exist in the Consolidation Advice message will be detached.

Interchange Acknowledgment (IRA) event will be sent back to NVOCC (message sender) once successfully created the consolidation and linking the Shipments. If at least one Shipment was attached to another Consolidation, then the Consolidation Advice messages should be rejected with message: ‘Shipment(s) on Consolidation Advice has been linked to another Consolidation’. Interchange Rejection (IRJ) event will be sent back to NVOCC (message sender) with the above reason.

When a Consolidation Advice in the receiving CargoWise system has been processed correctly, the Reference Number with Type=HIR will be added and set ‘read only’. It will also update the Co-Load Booking Ref which was received in the Consolidation Advice. If NVOCC send a Co-Load MBL in the same message, that will also be updated to the Consolidation.

### Receipt of a Consolidation Advice by Booking Party

This section explains the process from the Booking Party's (Forwarder/Shipper/BCO) point of view. A Consolidation Advice message received from an NVOCC will be processed into the system of the Booking Party and will create new or update an existing consolidation and attach to it shipments consolidated by the NVOCC.

The following section explains in detail what happens with Consolidation Advice data received into booking party's system.

### Matching and Update Logic

Upon receipt of Consolidation Advice by the booking party system, the system will use Co-Load MBL and/or Co-Load Booking Reference fields to match and update the existing Consolidations:
A new Co-Load Consolidation will be created in Booking Party's system if NO matching consolidation is found.
If the existing Consolidation has the shipment numbers that match the sub shipment numbers in the Consolidation Advice message, but the Consolidation has no Co-Load Booking Ref and/or Co-load MBL entered, system will still match this Consolidation and update it. In other words, if you've submitted booking requests from your bookings/shipments and then later manually created a CLD consol in your system without co-load master bill and/or booking reference, Consolidation Advice will match to this consol and update it.
If existing Consolidation is successfully matched but if the Consolidation type is not CLD, then the Consolidation will be converted to CLD by the Consolidation Advice message.
If existing Consolidation is successfully matched but it has Shipments that are not included in the Consolidation Advice message, then those Shipments will be detached from the Consolidation, and only the Shipments sent in the Consolidation Advice message will be attached to this Consolidation. In other words, if you have created Consolidation in your system, but included more shipments than were consolidated by NVOCC, these extra shipments will be detached from the consolidation to match with the NVOCC system.
If existing Consolidation A is successfully matched but at least one shipment in the Consolidation Advice message was attached to Consolidation B by the Booking Party, then the Consolidation Advice will be rejected with message: ‘Shipment(s) on Consolidation Advice has been linked to another Consolidation’. Interchange Rejection (IRJ) event will be sent back to NVOCC with above reason.
If Consolidation Advice is received with additional Shipments besides those that have been attached to the matched Consolidation, and the additional Shipments are not attached to another Consolidation, then the additional Shipments will be automatically attached to this Consolidation.
If Consolidation Advice is received with additional Shipments besides those that have been attached the matched Consolidation, and at least one additional Shipment is attached to another Consolidation, the Consolidation Advice will be rejected.

In case of an amendment Consolidation Advice (Document Name=‘Consolidation Advice’ and Purpose=‘AMD’), the Booking Party's system will try to find a matching Consolidation using the following criteria:
‘CoLoadBookingConfirmationReference’ match the Co-Load Bkg Ref in the consol; and/or
‘CoLoadMasterBillNumber’ match the Co-Load MBL in the consol; and/or
Value of AdditionalReference of Type ‘HIR’ match the Consolidation>Details>Numbers [Type=HIR]

Then all Shipments in the Consolidation Advice message will be validated to check if they are attached to another Consolidation or not. If none of shipments are linked to another Consolidation, then the matched Consolidation can be updated:
New matching shipments will be attached
Shipments which do not exist in the Consolidation Advice message will be detached.

Interchange Acknowledgment (IRA) event will be sent back to NVOCC (message sender) once successfully created the consolidation and linking the Shipments.

If at least one Shipment was attached to another Consolidation, then the Consolidation Advice messages should be rejected with message: ‘Shipment(s) on Consolidation Advice has been linked to another Consolidation’. Interchange Rejection (IRJ) event will be sent back to NVOCC (message sender) with the above reason.

### REFERENCE NUMBERS

When a Consolidation Advice in the receiving system has been processed correctly, the Reference Number with Type=HIR will be added and set ‘read only’. It will also update the Co-Load Booking Ref which was received in the Consolidation Advice. If NVOCC send a Co-Load MBL in the same message, that will also be updated to the Consolidation.

How to check the status of Consolidation Advice

The following events will be automatically generated in the Booking Party's system and will be visible in Consolidation events log.
MRR—Message Received event will be added to the Consolidation event log once Consolidation Advice message is processed and created or updates the Consolidation.

Event Parameters:
MST=Consolidation Advice
MSB=<Original or Amendment>
Event Reference Text: from Carrier
Event Reference: from Carrier|MST=Consolidation Advice|MSB=<purpose>
Event Details field clearly explains to the users when and why the status was changed, and the earlier status it was changed from: |14 © 2022 WiseTech Global

### How to View Consolidation Advice Document

Once the MRR event is processed the Consolidation Advice will be attached to the Consolidation>eDocs tab with a Document Type COA—Consolidation Advice.

### Methods

This section provides methods that have been disclosed in more detail above. In particular, FIG. 10 illustrates a method 1000 for synchronising merged records between databases. Method 1000 way me performed by a carrier computer system and comprises receiving 1001, by the carrier computer system, from one or more freight forwarder computer systems, electronic booking messages. The electronic booking messages comprise multiple bookings for transportation of physical cargo. The carrier computer system further creates 1002, in a database of the carrier computer system, a record for a consolidated booking, the consolidated booking comprising the multiple booking. Then, the carrier computer system sends 1003 to the one or more freight forwarder computer systems, a consolidation advice message indicative of the multiple bookings consolidated into the consolidated booking. Thereafter, the carrier computer system monitors for an acknowledgement message from the one or more freight forwarder computer systems indicating that records in the one or more freight forwarder computer systems that correspond to consolidated records in the carrier computer system have been consolidated in the one or more freight forwarder computer systems to thereby synchronise the merged records.

FIG. 11 illustrates a method 1100 for synchronising merged records between databases. Method 1100 may be performed by a freight forwarder computer system and comprises sending 1101 electronic booking messages to a carrier computer system. The electronic booking messages comprise multiple bookings for transportation of physical cargo. The freight forwarder computer system then receives, from the carrier computer system, a consolidation advice message indicative of multiple bookings consolidated into a consolidated booking by the carrier computer system. In response, the freight forwarder computer system consolidates 1103 the multiple bookings corresponding to the multiple bookings in the consolidation advice message to synchronise the merged records to a database of the carrier computer system. Finally, the freight forwarder computer system sends 1104 an acknowledgement message indicating that records in the freight forwarder computer system that correspond to consolidated records in the carrier computer system have been consolidated in the freight forwarder computer system to thereby synchronise the merged records.

FIG. 12 illustrates a method 1200 for optimising usage of cargo capacity in one or more containers. The method 1200 comprises sending 1201, by a freight forwarder computer system, an electronic booking message to a carrier computer system. The electronic booking message comprises a booking for transportation of physical cargo within the one or more containers. Method 1200 further comprise continuously transporting 1202 the physical cargo to a carrier cargo processing facility and allocating 1203, by the carrier computer system, the physical cargo to the one or more containers associated with the booking and the one or more containers to a cargo vessel. Upon completion of allocating the physical cargo to the one or more containers and to the cargo vessel, the carrier computer system automatically creates and sends 1204 a cargo receipt advice message to the freight forwarder computer system. The cargo receipt advice message comprises information regarding the allocation of the physical cargo to the one or more containers and a cargo vessel. Method 1200 further comprises determining 1206, by the freight forwarder computer system, using the information regarding the cargo vessel, an estimated time of arrival of the physical cargo at a destination of the physical cargo. The freight forwarder computer system then determines 1206 an unused amount of cargo capacity by determining a volume of the allocated physical cargo using the information regarding the allocation of the physical cargo and subtracting the volume from the cargo capacity and adds 1207 further cargo to the booking to reduce the unused amount of cargo capacity. Finally, the freight forwarder computer system creates 1208, a bill of lading for the booking including the physical cargo and the further cargo.

### Computer System

FIG. 13 illustrates a computer system 1300 comprising a processor 1301, program memory 1302, data memory 1303 and a communication interface 1304. Computer system 1300 may comprise a single processor 1301 as shown or multiple processors. The single processor 1301 or the multiple processors individually or in combination are configured to perform the methods disclosed herein. In particular, the processor(s) are configured, by way of program code stored on a non-transitory computer readable medium, i.e. program memory 1302 to perform methods, such as methods 1000, 1100, 1200. Computer system 1300 further comprises data memory 1303, which may host a database, such as an SQL database. The database stored on data memory 1303 may store the multiple bookings discussed above as separate records on the database. Of course, there may be multiple tables and the data for each record may be spread across the multiple tables. For example, one table may store associations between multiple bookings and one consol so as to store a consolidated booking.

It is noted that that freight forwarder 101 and NVOCC 102 may be implemented with similar computer systems as shown in FIG. 13 with the main difference that each system stores different shipments. In other words, the shipments are not stored on a central database but are duplicated over the multiple computer systems. For this reason, this disclosure provides a technology to synchronise the merging of different bookings across the different computer systems using consolidation advice messages. It is further noted that the different databases may be stored centrally on the same SQL server, such as in a web service or web application. However, even in this configuration, the booking records are duplicated since they exist in both domains on the same server. The web service may be hosted by a central computer that is separate and remote from both the systems of freight forwarder 101 and the NVOCC 102. In that sense, the freight forwarder 101 and NVOCC 102 can log into the central computer/server under their account and administer their bookings. Under the NVOCC 102 account, the bookings can be consolidated and the consolidation advice message can be sent internally to the account of the freight forwarder 101 to also consolidate the corresponding shipment records there.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for synchronising merged records between databases as performed by a carrier computer system, the method comprising:
receiving, by a carrier computer system, from one or more freight forwarder computer systems, electronic booking messages, the electronic booking messages comprising multiple bookings for transportation of physical cargo;
creating, in a database of the carrier computer system, a record for a consolidated booking, the consolidated booking comprising the multiple bookings;
sending, from the carrier computer system to the one or more freight forwarder computer systems, a consolidation advice message indicative of the multiple bookings consolidated into the consolidated booking; and
monitoring for an acknowledgement message from the one or more freight forwarder computer systems indicating that records in the one or more freight forwarder computer systems that correspond to consolidated records in the carrier computer system have been consolidated in the one or more freight forwarder computer systems to thereby synchronise the merged records.

2. A method for synchronising merged records between databases as performed by a freight forwarder computer system, the method comprising:
sending, by the freight forwarder computer system, electronic booking messages to a carrier computer system, the electronic booking messages comprising multiple bookings for transportation of physical cargo;
receiving, from the carrier computer system, a consolidation advice message indicative of multiple bookings consolidated into a consolidated booking by the carrier computer system;
consolidating the multiple bookings corresponding to the multiple bookings in the consolidation advice message to synchronise the merged records to a database of the carrier computer system; and
sending an acknowledgement message indicating that records in the freight forwarder computer system that correspond to consolidated records in the carrier computer system have been consolidated in the freight forwarder computer system to thereby synchronise the merged records.

3. The method of claim 2, wherein the method further comprises:
determining whether the consolidated bookings from the carrier computer system correspond to bookings already consolidated on the freight forwarder computer system;
upon determining that the consolidated bookings from the carrier computer system are already consolidated, sending a reject message to the carrier computer system.

4. The method of claim 3, wherein determining whether the consolidated bookings correspond to bookings already consolidated comprises determining whether the consolidation is inconsistent between the carrier computer system and the freight forwarder computer system.

5. The method of any one of the preceding claims, wherein the bookings relate to bookings for sea transport.

6. The method of any one of the preceding claims, wherein the consolidated booking relates to a single container that contains the multiple consolidated bookings.

7. The method of claim 6, wherein the container contains consolidated bookings from different freight forwarder computer systems.

8. The method of any one of the preceding claims, wherein the method further comprises sending, from the carrier computer system, to the freight forwarder computer system, tracking updates on the consolidated booking while the consolidated booking is shipped.

9. A method for optimising usage of cargo capacity in one or more containers, the method comprising:
sending, by a freight forwarder computer system, an electronic booking message to a carrier computer system, the electronic booking message comprising a booking for transportation of physical cargo within the one or more containers;
continuously transporting the physical cargo to a carrier cargo processing facility;
allocating, by the carrier computer system, the physical cargo to the one or more containers associated with the booking and the one or more containers to a cargo vessel;
upon completion of allocating the physical cargo to the one or more containers and to the cargo vessel, automatically creating and sending, by the carrier computer system, a cargo receipt advice message to the freight forwarder computer system, the cargo receipt advice message comprising information regarding the allocation of the physical cargo to the one or more containers and a cargo vessel;
determining, by the freight forwarder computer system, using the information regarding the cargo vessel, an estimated time of arrival of the physical cargo at a destination of the physical cargo;
determining, by the freight forwarder computer system, an unused amount of cargo capacity by determining a volume of the allocated physical cargo using the information regarding the allocation of the physical cargo and subtracting the volume from the cargo capacity;
adding, by the freight forwarder computer system, further cargo to the booking to reduce the unused amount of cargo capacity; and
creating, by the freight forwarder computer system, a bill of lading for the booking including the physical cargo and the further cargo.

10. The method of claim 9, wherein the method further comprises sending, by the freight forwarder computer system, electronic booking messages to the carrier computer system, the electronic booking messages comprising multiple bookings for transportation of physical cargo.

11. The method of claim 10, wherein the method further comprises creating, by the carrier computer system in a database of the carrier computer system, a record for a consolidated booking, the consolidated booking comprising the multiple bookings.

12. The method of any one of claims 9 to 11, wherein the method further comprises receiving, from the carrier computer system, a consolidation advice message indicative of multiple bookings consolidated into a consolidated booking by the carrier computer system.

13. The method of claim 12, wherein the method further comprises consolidating, by the freight forwarder computer system, the multiple bookings corresponding to the multiple bookings in the consolidation advice message to synchronise the merged records to a database of the carrier computer system.

14. The method of claim 13, wherein the method further comprises monitoring for an acknowledgement message from the one or more freight forwarder computer systems indicating that records in the one or more freight forwarder computer systems that correspond to consolidated records in the carrier computer system have been consolidated in the one or more freight forwarder computer systems to thereby synchronise the merged records.

15. The method of claim 13 or 14, wherein the method further comprises sending, by the freight forwarder computer system, an acknowledgement message indicating that records in the freight forwarder computer system that correspond to consolidated records in the carrier computer system have been consolidated in the freight forwarder computer system to thereby synchronise the merged records.

16. The method of any one of claims 12 to 14, wherein the method further comprises performing by the freight forwarder computer system the steps of:
determining whether the consolidated bookings from the carrier computer system correspond to bookings already consolidated on the freight forwarder computer system; and
upon determining that the consolidated bookings from the carrier computer system are already consolidated, sending a reject message to the carrier computer system.

17. The method of claim 16, wherein determining whether the consolidated bookings correspond to bookings already consolidated comprises determining whether the consolidation is inconsistent between the carrier computer system and the freight forwarder computer system.

18. The method of any one of claims 12 to 17, wherein the consolidated booking relates to a single container that contains the multiple consolidated bookings.

19. The method of claim 18, wherein the container contains consolidated bookings from different freight forwarder computer systems.

20. A computer system comprising one or more processors that are configured to individually or in combination perform the method of any one of the preceding claims.
